(19) United States
(12) Patent Application Publication
(10) Pub. No.: US 2020/0288724 A1
(43) Pub. Date: Sep. 17, 2020

(54) COMPOSITION FOR CONTROL OF RODENTS

(71) Applicant: Filip Lech, Middle Village, NY (US)

(72) Inventor: Filip Lech, Middle Village, NY (US)

(21) Appl. No.: 16/298,298

(22) Filed: Mar. 11, 2019

(51) Int. Cl. A01N 65/12; A01N 25/08

(52) U.S. Cl. CPC A01N 65/12; A01N 25/08

(57) ABSTRACT

A rodent-repelling composition in accordance with the present invention formed by combining an amount of diatomaceous earth, preferably food grade, with a small amount of water and a chamomile element, e.g., a few drops of chamomile essential oil. Potency of the composition can be increased by the addition of a small amount of finely-divided, i.e., ground, chamomile. Either German or wild chamomile (Matricaria recutita) or Roman, English, or garden chamomile (Chamaemelum nobile) are suitable. In a method for using the above rodent-repelling composition, the composition is placed in an area known or believed to be inhabited or trafficked by rodents. Alternatively, the composition may be placed directly in rodent runs or nests.

### FIELD OF THE INVENTION

This disclosure relates generally to compositions for deterring or killing rodents and, more specifically, to a composition comprising an essential oil dispersed in diatomaceous earth, and most specifically, to a composition comprising the herb chamomile, finely-divided, and/or chamomile essential oil dispersed in diatomaceous earth.

### BACKGROUND OF THE INVENTION

U.S. Pat. No. 5,402,597, issued Apr. 4, 1995 to Lech, which is incorporated by reference herein in its entirety, discloses a novel method for repelling rodents such as rats and mice, including the step of placing an effective amount of chamomile in an area where rodents are not desired. A drawback of this method is that the effective aroma of chamomile dissipates in an undesirably short period of time.

It is known to use diatomaceous earth to drive away insects such as cockroaches and ants, which dislike walking across a surface covered in diatomaceous earth. It is further known to impregnate diatomaceous earth with some aromatic compounds, such as peppermint oil or citrus oil, to form a composition that is repellent to rodents.

Several US patents and/or published patent applications disclose compositions for repelling or killing rodents or insects comprising both chamomile and diatomaceous earth, but each such disclosure requires inclusion of one or more additional compounds, as follows:

US 2017/0118998 discloses a pesticidal composition comprising rosemary oil and wintergreen oil with a suitable carrier with or without one or more additional essential oil compounds. The carrier may be diatomaceous earth and the additional essential oil may be chamomile.

U.S. Pat. No. 9,756,857 discloses a pest-combating composition including sodium lauryl sulfate and one or more of C6-12 fatty acids, preferably lauric and/or capric and/or caprylic acid, soy methyl ester, and 2-undecanone, and methods of combating pests utilizing same. The composition may include natural fragrances such as chamomile oil and dustable powders such as diatomaceous earth.

US 2006/0135645 and US 2006/0134040 disclose a method and composition for preventing insect infestation by applying to the area to be protected an effective amount of solid material coated with a composition comprising a silicone polymer and an essential oil which may be chamomile oil. The solid material may comprise diatomaceous earth.

U.S. Pat. No. 7,232,844 and U.S. Pat. No. 9,314,021 disclose dihydronepetalactone and its stereoisomers, a minor natural constituent of the essential oil of catmints such as Nepeta cataria, as an effective insect repellent compound. Chamomile oil may be added, and diatomaceous earth may be used as a solid carrier.

EP 1,916,893 discloses a composition characterized by a special combination consisting of one or more disinfecting substances and one or more stabilizing substances for use as a disinfectant. The invention also relates to a composition that, as an additional constituent, comprises one or more insecticidal substances and to the use thereof as an insecticide. In addition, it has been found that a further significant improvement of the disinfecting and insecticidal activity of the composition can be achieved if one or more plant extracts such as chamomile is added. The composition may further comprise diatomaceous earth.

US 2018/0325801 discloses compositions that provide release of fragrance over an extended period of time. The compositions comprise a hydrophilically-modified cross-linked silicone elastomer, an acrylic rheology modifier, and a fragrance oil which may be chamomile oil. Diatomaceous earth may be used as a filler.

U.S. Pat. No. 9,994,557 discloses a plant propagation material comprising a natural or synthetic strigolactone compound and one or more pesticides. The natural strigolactone may be derived from chamomile. Diatomaceous earth may be used as a carrier.

WO 2017/035099 discloses a non-toxic pest control composition comprising a treated fermented bacterial supernatant and one or more non-ionic surfactants, all at pH below 5, and an abrasive agent which may be diatomaceous earth. A plant essential oil such as chamomile oil may be included.

US 2010/0040705 discloses a pest repellent having long lasting and high repelling efficacy against sanitary insects such as mosquitoes and which is highly harmless to humans. In at least one embodiment, the pest repellent contains copaiba oil and/or an extract thereof as well as DEET and/or bisabolol, which may be extracted from bisabolol. Diatomaceous earth may be used as a carrier.

US 2007/0190094 discloses pesticidal compositions containing a pesticidally acceptable carrier and at least one isopropyl-containing compound as a pesticidally active ingredient. Optionally, a suitable essential oil such as chamomile oil may be included, as well as a carrier such as diatomaceous earth.

U.S. Pat. No. 7,465,700 discloses a cleaning composition comprising alkyl polyglucoside, ethanol, colloidal silica, and glycerol. Such compositions may further comprise essential oils such as chamomile oil and a filler such as diatomaceous earth.

An article titled “Benefits of using diatomaceous earth in the organic garden”, found at http://www.seattleseed.com/blog/benefits-of-using-diatomaceous-earth-in-the-organic-garden, discloses that rats, mole, mice, and rabbits can be deterred from visiting the garden with the use of diatomaceous earth, preferably with addition of a few drops of the essential oil of lemon or peppermint (rodents hate both).

An article titled “How do I get rid of rats quickly?”, found at http://bugrepel.com/rats:html, discloses a composition comprising diatomaceous earth and an essential oil selected from the group consisting of peppermint, wintermint, orange, lemongrass, catnip, clove, and spearmint.

It is not known heretofore that compositions comprising solely finely-divided chamomile and/or chamomile essential oil dispersed in diatomaceous earth are highly repellent to rodents and are far-longer lasting in repellency than chamomile alone as disclosed in the '597 patent cited hereinabove.

### SUMMARY OF THE INVENTION

A rodent-repelling composition in accordance with the present invention may be formed by combining an amount of diatomaceous earth, preferably food grade, with a small amount of water and a chamomile element, e.g., a few drops of chamomile essential oil. Potency of the composition can be increased by the addition of a small amount of finely-divided chamomile, i.e., ground chamomile. Either German or wild chamomile (Matricaria recutita) or Roman, English, or garden chamomile (Chamaemelum nobile) are suitable.

In a method for using the above rodent--repelling composition, the composition is spread in an area known or believed to be inhabited or trafficked by rodents. Alternatively, the composition may be placed. directly in rodent runs or nests.

### DETAILED DESCRIPTION OF THE INVENTION

In a presently preferred rodent-repelling composition in accordance with the present invention, an amount of diatomaceous earth, e.g., one cup (preferably food grade), a small amount of water, e.g., one-eighth cup, and a few drops of chamomile essential oil, e.g., 2-3 drops, are combined. Potency of the composition can be increased by the addition of a small amount, e.g., one ounce, of ground dried chamomile. Either German or wild chamomile (Matricaria recutita) or Roman, English, or garden chamomile (Chamaemulus nobile) are suitable.

In a presently preferred method for making the above composition, the water is mixed with the oil and/or ground chamomile, then the resulting mixture is mixed into the diatomaceous earth.

In a method for using the above rodent-repelling composition, the composition is placed in an open container in an area known or believed to be inhabited or trafficked by rodents, or the composition may be placed directly in rodent runs or nests.

When the aroma of the composition becomes reduced over time, potency may be restored by the addition of a little water and then shaking and/or kneading the composition to present fresh material at the surface. Further potency can be achieved by addition of more chamomile essential oil and/or ground chamomile.

When not in use, the composition should be stored in an air-tight container to prevent loss of potency.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses, and methods can be practiced with fewer than the mentioned certain number of elements. Also, while a number of particular embodiments have been described, it will be understood that features and aspects that have been described with reference to each particular embodiment can be used with each remaining particularly described embodiment.

What is claimed is:

1. A composition for repelling rodents, comprising:
a) diatomaceous earth; and
b) a chamomile element,
wherein said chamomile element is selected from the group consisting of chamomile essential oil, finely-divided chamomile, and combinations thereof.

2. A composition in accordance with claim 1 further comprising water.

3. A composition in accordance with claim 1 wherein said diatomaceous earth is of food grade.

4. A composition in accordance with claim 1 wherein said chamomile element is selected from the group consisting of Matricaria recutita, Chamaemulus nobile, and combinations thereof.

5. A method for making a composition for repelling rodents, comprising the steps of:
a) providing an amount of diatomaceous earth and at least one chamomile element; and
b) mixing said diatomaceous earth and said at least one chamomile element together to form a first uniform composition.

6. A method in accordance with claim 5, comprising the further steps of:
a) providing an amount of water; and
b) mixing said amount of water into said first uniform composition to form a second uniform composition.
